(19) United States
(12) Patent Application Publication
(10) Pub. No.: US 2007/0158260 A1
(43) Pub. Date: Jul. 12, 2007

(54) Rotational shearing filter

(75) Inventor: Gregor Mauer, Aachen (DE)

Correspondence Address: JORDAN AND HAMBURG LLP, 122 EAST 42ND STREET, SUITE 4000, NEW YORK, NY, 10168, US

(73) Assignee: Andreas Kufferath Gmbh & Co., KG, Dueren (DE)

(21) Appl. No.: 10/582,444

(22) PCT Filed: Dec. 6, 2004
(86) PCT No.: PCT/EP04/13840

§ 371 Date: Jun. 8, 2006

(30) Foreign Application Priority Data
Dec. 8, 2003 (DE) 10357520.0

(51) Int. Cl. B01D 35/16

(52) U.S. Cl. 210/331; 210/330; 210/346; 210/486

(57) ABSTRACT

A rotational shearing filter is disclosed which includes a housing and several spaced-apart, stationary, coaxial, annular, hollow filter disks that are disposed therein. Several shearing elements are retained in a torsion-proof manner on a central, rotatable drive shaft which penetrates the filter disks. The shearing elements are placed next to the annular surfaces of the filter disks, which point in the axial direction of the housing, so as to keep the filter disks penetrable for filtrate that penetrates from the housing into the filter disks. In order to prevent the shearing elements and the filter elements from touching each other as a result of thermal expansion, the shearing elements that are connected to the drive shaft so as to rotate therewith are guided thereon in an axially movable manner while spacers which axially displace the shearing elements according to longitudinal modifications of the housing occurring due to thermal conditions are positioned between the shearing elements. The spacers can be arranged directly between adjacent shearing elements and can be made of a material corresponding to the thermal expansion behavior of the housing. Alternatively, the spacers can be made of a largely random material while limiting the minimum distances between the shearing elements and the filter disks or the facing housing walls.

### BACKGROUND OF THE INVENTION

The invention relates to a rotational shearing filter having a housing and a plurality of spaced-apart, coaxial, annular, hollow filter disks arranged therein, whereby held rotationally fast on a rotatable central drive shaft that penetrates the filter disks are a plurality of shearing elements that are adjacent to the annular surfaces of the filter disks in the axial direction of the housing for maintaining their filter permeability for filtrate that penetrates out of the housing into the filter disks.

For proper operating, it is necessary that the shearing elements that act as stirrers never touch the filter disks, because this would lead to immediate destruction of the latter. The drive shaft must be able to absorb forces that occur during operation and must never bow appreciably. For this reason the drive shaft generally comprises metal such as for instance steel or high-grade steel. The drive shaft and the filter disks must have very similar heat expansion behavior in order to avoid having the stirrers or shearing elements come into contact with the filter disks. Therefore the housing is generally produced from the same or at least a very similar material as the drive shaft. If the housing comprises a material other than that of the drive shaft that differs in its expansion behavior from that of the drive shaft, the shearing elements must be spaced relatively distant from the filter disks. This limits the number of shearing elements and filter disks because the effect of the heat expansion increases as the height of the stack increases.

### BRIEF SUMMARY OF THE INVENTION

The object of the present invention is to contrive a rotational shearing filter such that regardless of the material selection, and thus regardless of the thermal expansion behavior of the drive shaft and housing, there is no risk of the shearing elements and the filter disks coming into contact with one another. This is also to be the case when the distances between the shearing elements and the filter disks are selected to be particularly small in order to assure optimum use of space.

For attaining this object, a rotational shearing filter according to one embodiment of the invention comprises shearing elements that are joined to the drive shaft so as to rotate therewith are guided thereon in an axially displaceable manner and wherein allocated to the shearing elements are spacers that axially displace the shearing elements corresponding to longitudinal changes in the housing caused by thermal conditions.

Because of this, mutual contact between the shearing elements that act like stirrers and the filter disks can be avoided with certainty in a simple manner. It makes no difference which materials are used for the housing or the drive shaft or how small the distances are between the parts that are movable relative to one another. Constant axial adjustment of the shearing elements occurs corresponding to the heat expansion of the housing and thus corresponding to the positions of the filter disks that are a function thereof.

In accordance with further embodiments of the invention, spacers are adapted to the housing in terms of their heat expansion properties to ensure that no damaging mutual contact occurs.

In accordance with further embodiments of the invention, spacers are embodied as sliding bushes to ensure that damaging mutual contact is prevented. This structural form is particularly simple, economical, and practical.

In accordance with further embodiments of the invention, the shearing elements can also be axially displaced by parts of the housing or on the housing in order to prevent mutual contact.

### BRIEF DESCRIPTION OF THE DRAWINGS

Accompanying the specification are figures which assist in illustrating the embodiments of the invention, in which:

FIG. 1 illustrates a simplified section of a rotational shearing filter in accordance with the prior art;

FIG. 2 illustrates a simplified section of a first exemplary embodiment of a rotational shearing filter in accordance with the present invention; and

FIG. 3 illustrates a simplified section of a second exemplary embodiment of a rotational shearing filter in accordance with the present invention.

### DETAILED DESCRIPTION OF THE INVENTION

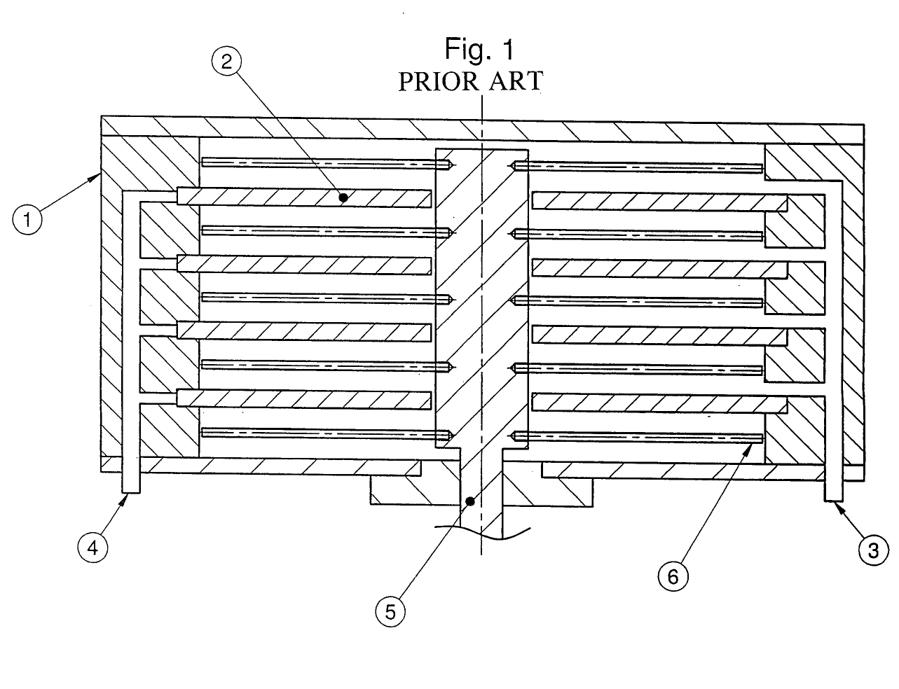

In a known rotational shearing filter in accordance with FIG. 1, a plurality of annular hollow filter disks 2 are arranged spaced apart in a cylindrical metallic housing 1 and held in annular receiving depressions of the housing 1. A suspension for filtering can be introduced into the interior housing areas between the filter disks 2 via a branching suspension inlet 3 embodied in the housing 1. From there the liquid components of the suspension can flow into the interior of the filter disks 2 in a filtered manner and then flow out via a branched filtrate outlet 4 embodied in the housing 1. A housing outlet (not shown) corresponding to the suspension inlet 3 drains the viscous medium enriched with solids out of the housing 1.

In order to prevent loading of the filter disks 2, during operation their surfaces are passed over in a contactless manner by shearing elements 6 that are inserted between the filter disks 2 and that are attached to a rotatably driven central drive shaft 5 so as to rotate therewith. The drive shaft 5 must absorb the forces that occur during operation and must not bow appreciably. Therefore and for attaining matching thermal expansion behavior, in the prior art it generally comprises the same metal as the housing, such as steel or high-grade steel.

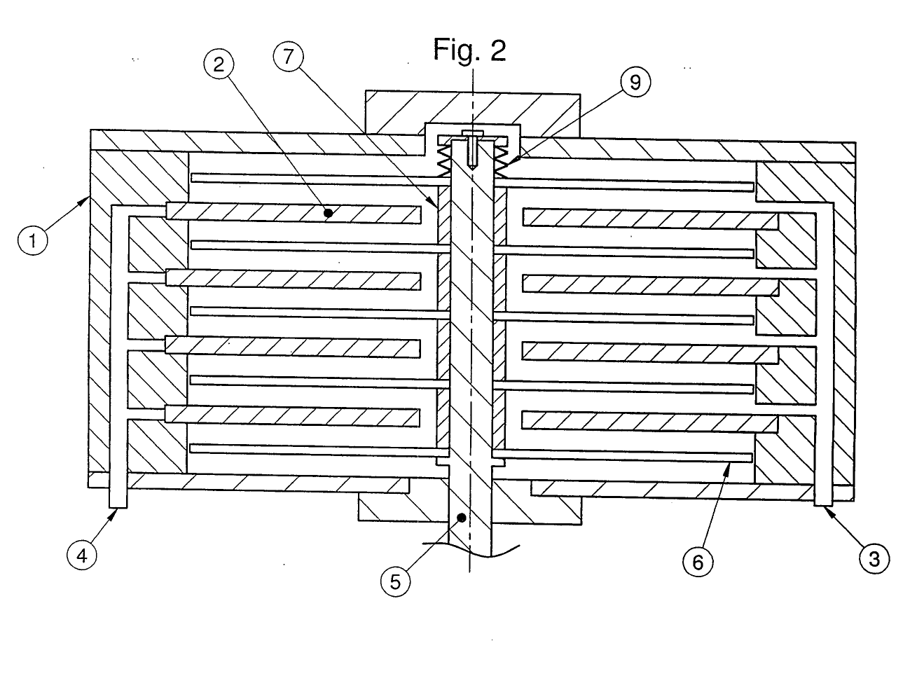

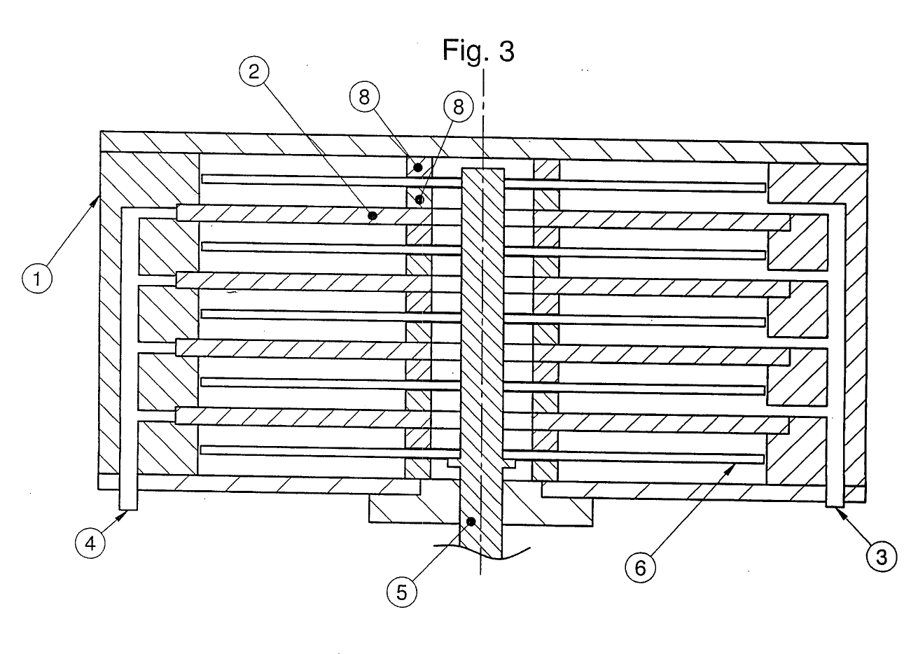

The inventive exemplary embodiments in FIGS. 2 and 3 are distinguished from the prior art in accordance with FIG. 1 largely in that the shearing elements 6 attached to the central drive shaft 5 so as to rotate therewith are guided on the drive shaft 5 in a longitudinally displaceable manner. For this purpose it is for instance possible that the drive shaft 5 has at least one longitudinal groove or rib running in the axial direction in which the shearing elements 6 engage rotation-fast with a corresponding profile. The shearing elements 6 can for instance be embodied as annular or disk-shaped parts or even as ray-shaped parts. Their object is to keep the surfaces of the filter disks 2 clean, and thus functional, using contactless relative movements.

In accordance with FIG. 2, located between the longitudinally displaceable shearing elements 6 are annular spacers 7 that are in contact with the latter and that enclose the drive shaft 5 with slight play and that are made of a material, the heat expansion of which largely matches that of the housing 1. In contrast with the prior art, the drive shaft 5 can therefore comprise a material with practically any thermal expansion behavior because the shearing elements 6 are borne longitudinally moveable and their positions are determined by the spacers 7. Since the behavior of the latter is similar to that of the housing 1, due to the material, there is no risk of the shearing elements 6 coming into contact with the filter disks 2.

In the rotational shearing filter in FIG. 2, an end-side shearing element 6 is positioned against a shoulder (not shown) of the drive shaft 5. At the other end, a pre-tension spring 9 that encloses and is detachably attached to the drive shaft 5 presses against another end-side shearing element 6. This means that all of the shearing elements 6 are pressed against one another with the spacers 7 located therebetween.

In accordance with FIG. 3, the shearing elements 6 that are longitudinally moveable on the drive shaft 5 are held by position using annular spacers 8 that are embodied as sliding bushes, that enclose the drive shaft 5 with a good deal of play, that can comprise any desired material in terms of their thermal expansion behavior, and that are attached to the filter disks 2. Center spacers 8 ensure the correct minimum distance between each adjacent shearing element 6. End-side spacers 8 attached to the housing 1 ensure that adjacent shearing elements 6 maintain the correct minimum distance from the housing 1. The spacers 8 always travel with the adjacent shearing elements 6 in a sliding catch.

In the exemplary embodiment in FIG. 3, as well, the housing 1 and the drive shaft 5 can comprise different materials. The thermal expansion behavior of these parts and also of the spacers 8 is of no consequence because the shearing elements 6 can only approach the filter disks 2 up to the thickness of the spacers 8.

In another exemplary embodiment (not shown), the spacers are embodied as interior projections or receiving depressions of the housing 1 that extend with the shearing elements 6 into a sliding catch that displaces them axially. These can be components thereof or can be embodied separately. These carrier-like parts also ensure that the shearing elements 6 are axially displaced according to the thermal expansions of the housing 1, and thus also of the filter disks 2.

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. All changes that come within the meaning and range of equivalency of the claims are to be embraced within their scope.

1.-12. (canceled)

13. A rotational shearing filter comprising:
an axially extending housing;
a plurality of spaced-apart, coaxial, annular, hollow filter disks disposed in said housing;
a rotatable central drive shaft penetrating said filter disks;
a plurality of axially displaceable shearing elements connected to said drive shaft and rotatable therewith;
said shearing elements being positioned adjacent to annular surfaces of said filter disks in the axial direction of said housing; and
said shearing elements including spacers that axially displace said shearing elements responsive to thermally induced changes in said housing.

14. The rotational shearing filter of claim 13, wherein said spacers are annular members that enclose said drive shaft.

15. The rotational shearing filter of claim 14, wherein said annular spacers are arranged between adjacent shearing elements, said spacers comprising a material having a coefficient of heat expansion that matches a coefficient of heat expansion of said housing.

16. The rotational shearing filter of claim 15 further comprising at least one pre-tension spring enclosing said drive shaft, said spring being disposed against at least one shearing element of said plurality of shearing elements and biasing said at least one shearing element towards other shearing elements of said plurality of shearing elements.

17. The rotational shearing filter of claim 16, further comprising a pair of opposing pre-tension springs enclosing said drive shaft, said plurality of shearing elements being disposed between said pair of opposing springs.

18. The rotational shearing filter of claim 16, wherein one of said plurality of shearing elements is positioned against a stop structure disposed on said drive shaft.

19. The rotational shearing filter of claim 16, wherein:
said annular spacers comprise sliding bushes that enclose said drive shaft;
said spacers being either opposing end spacers or spacers disposed between said end spacers;
said shearing elements being either opposing end shearing elements or shearing elements disposed between said end shearing elements;
each spacer being disposed between one of said plurality of filter disks and an adjacent one of said plurality of shearing elements; and
said end spacers being disposed between said end shearing elements and said housing.

20. The rotational shearing filter of claim 19, wherein said end spacers are connected to said housing and the remaining of said spacers are connected to said filter disks.

21. The rotational shearing filter of claim 13, wherein said drive shaft includes at least one axially extending groove or rib and said shearing elements include a profile adapted for interlocking with said groove or rib in said shaft.

22. The rotational shearing filter of claim 13, wherein said housing and said drive shaft comprise materials having different coefficients of thermal expansion.

23. The rotational shearing filter of claim 22, wherein said housing comprises plastic and said drive shaft comprises metal.

24. The rotational shaft shearing filter of claim 13, wherein said spacers comprise interior projections or receiving depressions of said housing that extend with said shearing elements into a sliding catch that axially displaces said spacers.
